(19) United States
(12) Patent Application Publication
(10) Pub. No.: US 2026/0086739 A1
(43) Pub. Date: Mar. 26, 2026

(54) STORAGE DEVICE AND OPERATING METHOD OF STORAGE DEVICE

(71) Applicant: SAMSUNG ELECTRONICS CO., LTD., Suwon-si (KR)

(72) Inventors: Youngjoon JANG, Suwon-si (KR); Junghwa LEE, Suwon-si (KR)

(73) Assignee: SAMSUNG ELECTRONICS CO., LTD., Suwon-si (KR)

(21) Appl. No.: 19/275,216

(22) Filed: Jul. 21, 2025

(30) Foreign Application Priority Data
Sep. 23, 2024 (KR) 10-2024-0128501

(51) Int. Cl. G06F 3/06

(52) U.S. Cl. CPC G06F 3/0659; G06F 3/0611; G06F 3/0619; G06F 3/0688

(57) ABSTRACT

A storage device includes a plurality of nonvolatile memory devices; and a memory controller configured to control the plurality of nonvolatile memory devices, wherein the memory controller is further configured to, in a copyback operation: transfer first read commands to first nonvolatile memory devices among the plurality of nonvolatile memory devices, transfer first program commands and first data read in response to the first read commands to second nonvolatile memory devices among the plurality of nonvolatile memory devices, and transfer suspend commands associated with the first program commands to the second nonvolatile memory devices.

### CROSS-REFERENCE TO RELATED APPLICATIONS

This application claims priority under 35 U.S.C. § 119 to Korean Patent Application No. 10-2024-0128501 filed on Sep. 23, 2024, in the Korean Intellectual Property Office, the disclosure of which is incorporated by reference herein in its entirety.

### BACKGROUND

Embodiments of the present disclosure relate to an electronic device, and more particularly, relate to a storage device with an improved operating speed and an operating method of the storage device.

A storage device may include a nonvolatile memory device and a memory controller. Depending on a request of an external host device, the memory controller of the storage device may write data in the nonvolatile memory device and may read data from the nonvolatile memory device.

The memory controller may buffer data read from the nonvolatile memory device and data to be written in the nonvolatile memory device by using an internal buffer or an external buffer. To reduce manufacturing costs of the storage device, the capacity of the internal buffer or the external buffer provided in the storage device may be restricted. The internal buffer or the external buffer with the restricted capacity may hinder the operating speed of the storage device.

### SUMMARY

Embodiments of the present disclosure provide a storage device providing an operating speed that may be improved by using a buffer of a restricted capacity and an operating method of the storage device.

According to an aspect of the disclosure, a storage device includes: a plurality of nonvolatile memory devices; and a memory controller configured to control the plurality of nonvolatile memory devices, wherein the memory controller is further configured to, in a copyback operation: transfer first read commands to first nonvolatile memory devices among the plurality of nonvolatile memory devices, transfer first program commands and first data read in response to the first read commands to second nonvolatile memory devices among the plurality of nonvolatile memory devices, and transfer suspend commands associated with the first program commands to the second nonvolatile memory devices.

According to an aspect of the disclosure, an operating method of a storage device which includes a plurality of nonvolatile memory devices and a memory controller, includes: transferring, by the memory controller, first read commands to first nonvolatile memory devices among the plurality of nonvolatile memory devices, in a copyback operation; transferring, by the memory controller, first program commands and first data read in response to the first read commands to second nonvolatile memory devices among the plurality of nonvolatile memory devices, in the copyback operation; and transferring, by the memory controller, suspend commands associated with the first program commands to the second nonvolatile memory devices, in the copyback operation.

According to an aspect of the disclosure, a storage device includes: a plurality of nonvolatile memory devices; and a memory controller configured to control the plurality of nonvolatile memory devices, wherein the memory controller is configured to, in a copyback operation belonging to a garbage collection operation: transfer first read commands to first nonvolatile memory devices among the plurality of nonvolatile memory devices, transfer first program commands and first data read in response to the first read commands to second nonvolatile memory devices among the plurality of nonvolatile memory devices, and transfer suspend commands associated with the first program commands to the second nonvolatile memory devices, wherein the memory controller is further configured to, in the copyback operation belonging to the garbage collection operation: transfer second read commands to third nonvolatile memory devices among the plurality of nonvolatile memory devices, and transfer second program commands and second data read by the second read commands to fourth nonvolatile memory devices among the plurality of nonvolatile memory devices, and wherein the memory controller is further configured to, in the copyback operation belonging to the garbage collection operation, transfer resume commands to the second nonvolatile memory devices after transferring the second data and the second program commands to the fourth nonvolatile memory devices.

### BRIEF DESCRIPTION OF THE DRAWINGS

The above and other aspects and features of the present disclosure will become apparent by describing in detail embodiments thereof with reference to the accompanying drawings, in which:

FIG. 1 is a diagram illustrating a storage device according to an embodiment of the present disclosure;

FIG. 2 is a block diagram illustrating a nonvolatile memory device according to an embodiment of the present disclosure;

FIG. 3 illustrates an example of memory blocks of nonvolatile memory devices;

FIG. 4 illustrates an example in which data are written in a first super block of nonvolatile memory devices;

FIG. 5 illustrates an example in which a portion of data written in nonvolatile memory devices is updated;

FIG. 6 illustrates an example in which garbage collection is performed in nonvolatile memory devices;

FIG. 7 illustrates an operating method of a storage device according to an embodiment of the present disclosure;

FIG. 8 illustrates an example in which the read and program operations for some nonvolatile memory devices among nonvolatile memory devices are requested;

FIG. 9 illustrates an example in which read and program operations for other nonvolatile memory devices among nonvolatile memory devices are requested;

FIG. 10 illustrates an example in which data are copied by the copyback operations of FIGS. 8 and 9;

FIG. 11 illustrates an example in which copyback operations are performed without suspend and resume;

FIG. 12 illustrates an example in which copyback operations are performed by using suspend and resume; and

FIG. 13 is a diagram illustrating a system to which a storage device according to an embodiment of the present disclosure is applied.

### DETAILED DESCRIPTION

Below, embodiments of the present disclosure will be described in detail and clearly to such an extent that an ordinary one in the art can easily carry out the present disclosure.

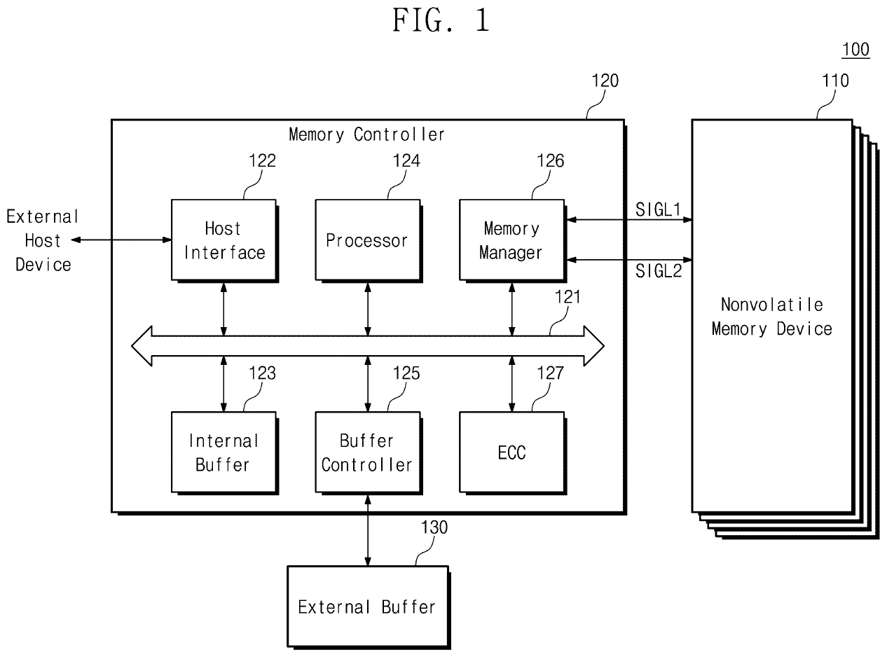

FIG. 1 illustrates a storage device 100 according to an embodiment of the present disclosure. Referring to FIG. 1, the storage device 100 may include nonvolatile memory devices 110, a memory controller 120, and an external buffer 130. The nonvolatile memory devices 110 may include a plurality of memory cells. Each of the plurality of memory cells may store two or more bits.

For example, the nonvolatile memory devices 110 may include at least one of various nonvolatile memory devices such as a flash memory device, a phase-change memory device, a ferroelectric memory device, a magnetic memory device, and a resistive memory device.

The memory controller 120 may receive various requests for writing data in the nonvolatile memory devices 110 or reading data from the nonvolatile memory devices 110, from an external host device. The memory controller 120 may store (or buffer) user data communicated with the external host device in the external buffer 130 and may store meta data for managing the storage device 100 in the external buffer 130.

The memory controller 120 may access the nonvolatile memory devices 110 through first signal lines SIGL1 and second signal lines SIGL2. For example, the memory controller 120 may transfer a command and an address to the nonvolatile memory devices 110 through the first signal lines SIGL1. The memory controller 120 may exchange data with the nonvolatile memory devices 110 through the first signal lines SIGL1.

The memory controller 120 may transfer a first control signal to the nonvolatile memory devices 110 through the second signal lines SIGL2. The memory controller 120 may receive a second control signal from the nonvolatile memory devices 110 through the second signal lines SIGL2.

In an embodiment, the memory controller 120 may be configured to control the nonvolatile memory devices 110. The memory controller 120 may provide the first signal lines SIGL1 and the second signal lines SIGL2 independently for each of the nonvolatile memory devices 110.

As another example, the memory controller 120 may share the first signal lines SIGL1 with the nonvolatile memory devices 110. The memory controller 120 may share some of the second signal lines SIGL2 with the nonvolatile memory devices 110, and the others thereof may be separately provided.

The external buffer 130 may include a random access memory. For example, the external buffer 130 may include at least one of a dynamic random access memory, a phase-change random access memory, a ferroelectric random access memory, a magnetic random access memory, and a resistive random access memory.

The memory controller 120 may include a bus 121, a host interface 122, an internal buffer 123, a processor 124, a buffer controller 125, a memory manager 126, and an error correction code (ECC) block 127.

The bus 121 may provide communication channels between the components of the memory controller 120. The host interface 122 may receive various requests from the external host device and may parse the received requests. The host interface 122 may store the parsed requests in the internal buffer 123.

The host interface 122 may transfer various responses to the external host device. The host interface 122 may exchange signals with the external host device in compliance with a given communication protocol. The internal buffer 123 may include a random access memory. For example, the internal buffer 123 may include a static random access memory or a dynamic random access memory.

The processor 124 may execute an operating system or firmware for driving the memory controller 120. The processor 124 may read the parsed requests stored in the internal buffer 123 and may generate addresses and commands for controlling the nonvolatile memory devices 110. The processor 124 may provide the generated commands and addresses to the memory manager 126.

The processor 124 may store various meta data for managing the storage device 100 in the internal buffer 123. The processor 124 may access the external buffer 130 through the buffer controller 125. The processor 124 may control the buffer controller 125 and the memory manager 126 such that the user data stored in the external buffer 130 are provided to the nonvolatile memory devices 110.

The processor 124 may control the host interface 122 and the buffer controller 125 such that the data stored in the external buffer 130 are provided to the external host device. The processor 124 may control the buffer controller 125 and the memory manager 126 such that the data received from the nonvolatile memory devices 110 are stored in the external buffer 130. The processor 124 may control the host interface 122 and the buffer controller 125 such that the data received from the external host device are stored in the external buffer 130.

Under control of the processor 124, the buffer controller 125 may write data in the external buffer 130 or may read data from the external buffer 130. The memory manager 126 may communicate with the nonvolatile memory devices 110 through the first signal lines SIGL1 and the second signal lines SIGL2 under control of the processor 124.

The memory manager 126 may access the nonvolatile memory devices 110 under control of the processor 124. For example, the memory manager 126 may access the nonvolatile memory devices 110 through the first signal lines SIGL1 and the second signal lines SIGL2. The memory manager 126 may communicate with the nonvolatile memory devices 110, based on a protocol defined in compliance with the standard or defined by a manufacturer.

The error correction code block 127 may perform error correction encoding for data to be provided to the nonvolatile memory devices 110 by using the error correction code ECC. The error correction code block 127 may perform error correction decoding for data received from the nonvolatile memory devices 110 by using the error correction code ECC.

In an embodiment, the external buffer 130 and the buffer controller 125 may be omitted in the storage device 100. When the external buffer 130 and the buffer controller 125 are omitted, the functions which are described as being performed by the external buffer 130 and the buffer controller 125 may be performed by the internal buffer 123.

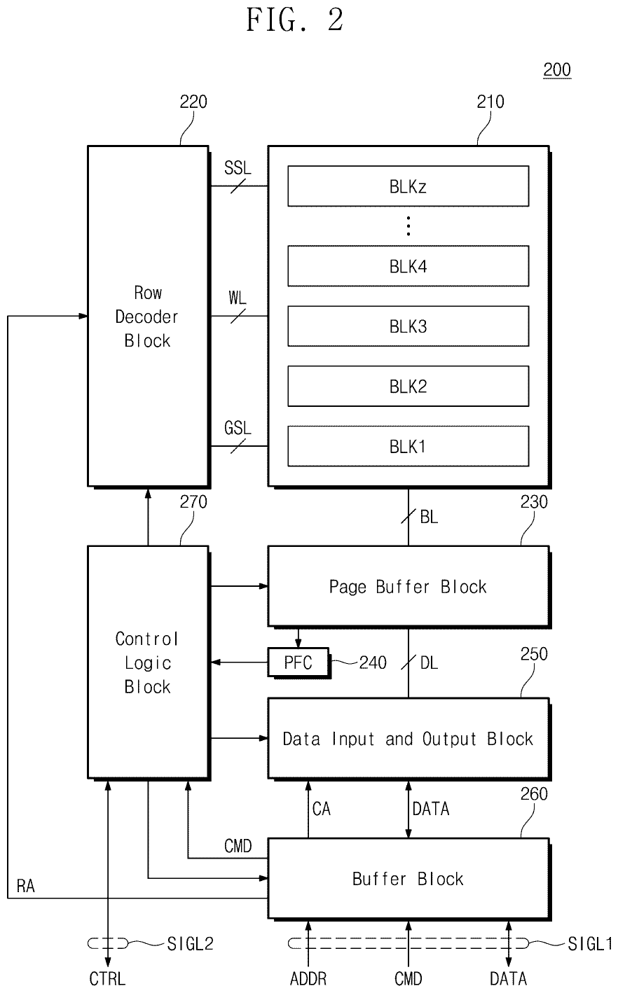

FIG. 2 is a block diagram illustrating a nonvolatile memory device 200 according to an embodiment of the present disclosure. Referring to FIG. 2, the nonvolatile memory device 200 may correspond to one of the nonvolatile memory devices 110 of FIG. 1. The nonvolatile memory device 200 may include a memory cell array 210, a row decoder block 220, a page buffer block 230, a pass/fail check block (PFC) 240, a data input and output block 250, a buffer block 260, and a control logic block 270.

The memory cell array 210 includes a plurality of memory blocks BLK1 to BLKz. Each of the memory blocks BLK1 to BLKz includes a plurality of memory cells. Each of the memory blocks BLK1 to BLKz may be connected to the row decoder block 220 through at least one ground selection line GSL, word lines WL, and at least one string selection line SSL. Some of the word lines WL may be used as dummy word lines. Each of the memory blocks BLK1 to BLKz may be connected to the page buffer block 230 through a plurality of bit lines BL. The plurality of memory blocks BLK1 to BLKz may be connected in common to the plurality of bit lines BL.

In an embodiment, each of the plurality of memory blocks BLK1 to BLKz may correspond to a unit of the erase operation. Memory cells belonging to each memory block may be erased at the same time. As another example, each of the memory blocks BLK1 to BLKz may be divided into a plurality of sub-blocks. Each of the plurality of sub-blocks may correspond to a unit of the erase operation.

The row decoder block 220 is connected to the memory cell array 210 through the ground selection lines GSL, the word lines WL, and the string selection lines SSL. The row decoder block 220 operates under control of the control logic block 270.

The row decoder block 220 may decode a row address RA received from the buffer block 260 and may control voltages to be applied to the string selection lines SSL, the word lines WL, and the ground selection lines GSL based on the decoded row address.

The page buffer block 230 is connected to the memory cell array 210 through the plurality of bit lines BL. The page buffer block 230 is connected to the data input and output block 250 through a plurality of data lines DL. The page buffer block 230 operates under control of the control logic block 270.

In the program operation, the page buffer block 230 may store data to be written in memory cells. The page buffer block 230 may apply voltages to the plurality of bit lines BL based on the stored data. In the read operation or in the verify read operation that is performed in the program operation or the erase operation, the page buffer block 230 may sense voltages of the bit lines BL and may store a sensing result.

In the verify read operation associated with the program operation or the erase operation, the pass/fail check block 240 may verify the sensing result of the page buffer block 230. For example, in the verify read operation which is performed in the program operation, the pass/fail check block 240 may count the number of values (e.g., the number of 0s) corresponding to on-cells which are not programmed to a target threshold voltage or higher.

In the verify read operation which is performed in the erase operation, the pass/fail check block 240 may count the number of values (e.g., the number of 1s) corresponding to off-cells which are not erased to a target threshold voltage or lower. When a counting result is greater than or equal to a threshold value, the pass/fail check block 240 may output a fail signal to the control logic block 270. When the counting result is smaller than the threshold value, the pass/fail check block 240 may output a pass signal to the control logic block 270. Depending on the verification result of the pass/fail check block 240, a program loop of the program operation may be further performed, or an erase loop of the erase operation may be further performed.

The data input and output block 250 is connected to the page buffer block 230 through the plurality of data lines DL. The data input and output block 250 may receive a column address CA from the buffer block 260. The data input and output block 250 may output the data read by the page buffer block 230 to the buffer block 260 depending on the column address CA. The data input and output block 250 may provide the data received from the buffer block 260 to the page buffer block 230, based on the column address CA.

Through the first signal lines SIGL1, the buffer block 260 may receive a command CMD and an address ADDR from an external device and may exchange data “DATA” with the external device. The buffer block 260 may operate under control of the control logic block 270. The buffer block 260 may provide the command CMD to the control logic block 270. The buffer block 260 may provide the row address RA of the address ADDR to the row decoder block 220 and may provide the column address CA of the address ADDR to the data input and output block 250. The buffer block 260 may exchange the data “DATA” with the data input and output block 250.

The control logic block 270 may exchange a control signal CTRL with the external device through the second signal lines SIGL2. The control logic block 270 may allow the buffer block 260 to route the command CMD, the address ADDR, and the data “DATA”. The control logic block 270 may decode the command CMD received from the buffer block 260 and may control the nonvolatile memory device 200 based on the decoded command.

In an embodiment, the nonvolatile memory device 200 may be manufactured in a bonding method. The memory cell array 210 may be manufactured by using a first wafer, and the row decoder block 220, the page buffer block 230, the pass/fail check block 240, the data input and output block 250, the buffer block 260, and the control logic block 270 may be manufactured by using a second wafer. The nonvolatile memory device 200 may be implemented by coupling the first wafer and the second wafer such that an upper surface of the first wafer and an upper surface of the second wafer face each other.

As another example, the nonvolatile memory device 200 may be manufactured in a cell over peri (COP) method. A peripheral circuit including the row decoder block 220, the page buffer block 230, the pass/fail check block 240, the data input and output block 250, the buffer block 260, and the control logic block 270 may be implemented on a substrate. The memory cell array 210 may be implemented over the peripheral circuit. The peripheral circuit and the memory cell array 210 may be connected by using the through vias.

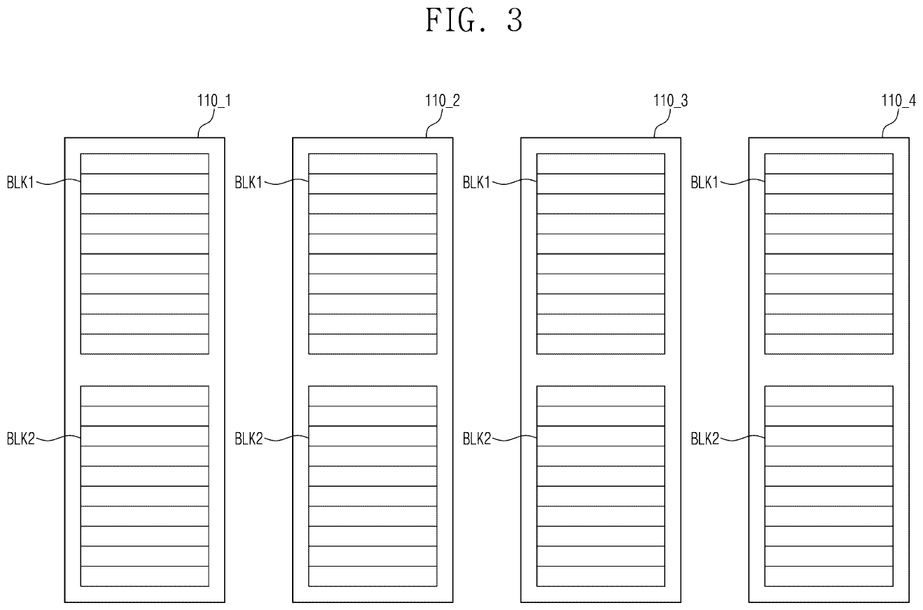

FIG. 3 illustrates an example of memory blocks of nonvolatile memory devices 110_1, 110_2, 110_3, and 110_4. Referring to FIGS. 1 and 3, an example of first memory blocks BLK1 and second memory blocks BLK2 of the nonvolatile memory devices 110_1, 110_2, 110_3, and 110_4 is illustrated.

Each of the first memory blocks BLK1 and the second memory blocks BLK2 of the nonvolatile memory devices 110_1, 110_2, 110_3, and 110_4 may include a plurality of pages. In FIG. 3, the plurality of pages are illustrated by squares in the first memory blocks BLK1 and the second memory blocks BLK2.

The nonvolatile memory devices 110_1, 110_2, 110_3, and 110_4 may be a plurality of nonvolatile memory chips included in one semiconductor package. In an embodiment, the memory controller 120 may control the nonvolatile memory devices 110_1, 110_2, 110_3, and 110_4 based on a super block.

The first memory blocks BLK1 of the nonvolatile memory devices 110_1, 110_2, 110_3, and 110_4 may be managed as a first super block. The memory controller 120 may sequentially write data at first pages of the first super block of the nonvolatile memory devices 110_1, 110_2, 110_3, and 110_4. When the data are written at the first pages of the first super block, the memory controller 120 may sequentially write data at second pages of the first super block of the nonvolatile memory devices 110_1, 110_2, 110_3, and 110_4.

The second memory blocks BLK2 of the nonvolatile memory devices 110_1, 110_2, 110_3, and 110_4 may be managed as a second super block. The memory controller 120 may sequentially write data at first pages of the second super block of the nonvolatile memory devices 110_1, 110_2, 110_3, and 110_4. When the data are written at the first pages of the second super block, the memory controller 120 may sequentially write data at second pages of the second super block of the nonvolatile memory devices 110_1, 110_2, 110_3, and 110_4.

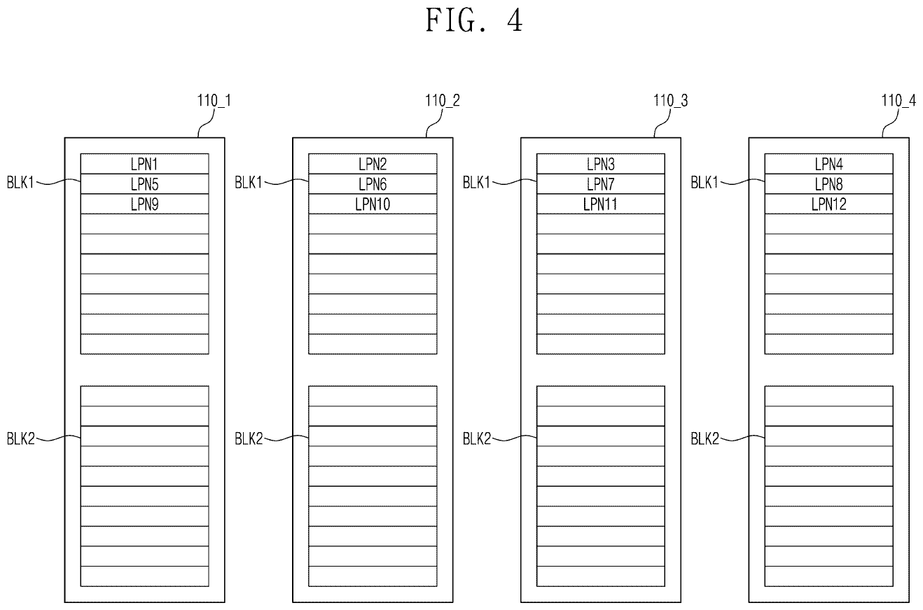

FIG. 4 illustrates an example in which data are written in the first super block of the nonvolatile memory devices 110_1, 110_2, 110_3, and 110_4. Referring to FIGS. 1 and 4, data may be written in the first super block of the nonvolatile memory devices 110_1, 110_2, 110_3, and 110_4.

For example, the memory controller 120 may sequentially receive data corresponding to 1st to 12th logical page numbers LPN1 to LPN12. The memory controller 120 may write data corresponding to the 1st to 12th logical page numbers LPN1 to LPN12 sequentially received, in the first super block.

The data of the 1st logical page number LPN1 may be written at the first page of the first memory block BLK1 of the first nonvolatile memory device 110_1. The data of the 2nd logical page number LPN2 may be written at the first page of the first memory block BLK1 of the second nonvolatile memory device 110_2. The data of the 3rd logical page number LPN3 may be written at the first page of the first memory block BLK1 of the third nonvolatile memory device 110_3. The data of the 4th logical page number LPN4 may be written at the first page of the first memory block BLK1 of the fourth nonvolatile memory device 110_4. In an embodiment, the first pages of the first super block may be regarded as one first super page.

The data of the 5th logical page number LPN5 may be written at the second page of the first memory block BLK1 of the first nonvolatile memory device 110_1. The data of the 6th logical page number LPN6 may be written at the second page of the first memory block BLK1 of the second nonvolatile memory device 110_2. The data of the 7th logical page number LPN7 may be written at the second page of the first memory block BLK1 of the third nonvolatile memory device 110_3. The data of the 8th logical page number LPN8 may be written at the second page of the first memory block BLK1 of the fourth nonvolatile memory device 110_4. In an embodiment, the second pages of the first super block may be regarded as one second super page.

The data of the 9th logical page number LPN9 may be written at the third page of the first memory block BLK1 of the first nonvolatile memory device 110_1. The data of the 10th logical page number LPN10 may be written at the third page of the first memory block BLK1 of the second nonvolatile memory device 110_2. The data of the 11th logical page number LPN11 may be written at the third page of the first memory block BLK1 of the third nonvolatile memory device 110_3. The data of the 12th logical page number LPN12 may be written at the third page of the first memory block BLK1 of the fourth nonvolatile memory device 110_4. In an embodiment, the third pages of the first super block may be regarded as one third super page.

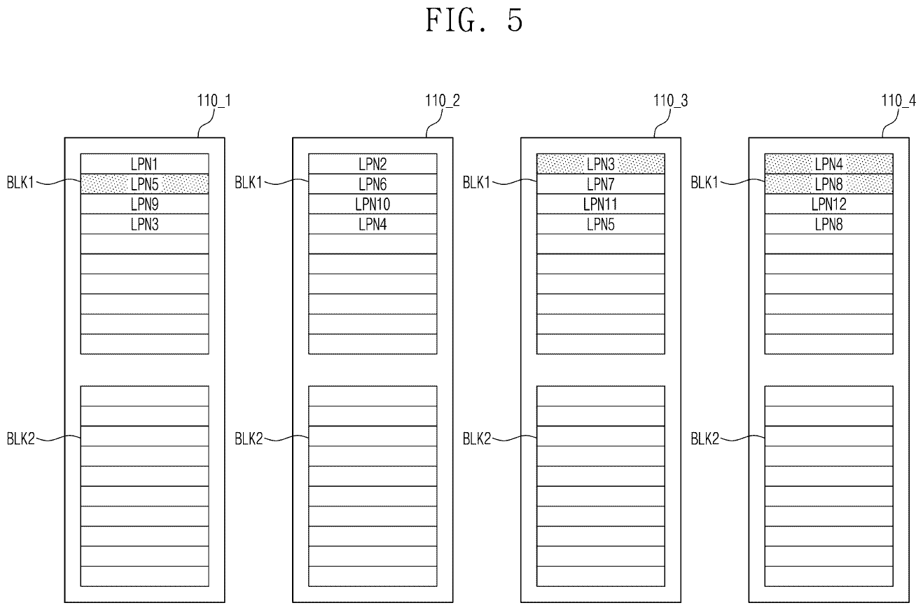

FIG. 5 illustrates an example in which a portion of data written in the nonvolatile memory devices 110_1, 110_2, 110_3, and 110_4 is updated. The nonvolatile memory devices 110_1, 110_2, 110_3, and 110_4 may not support the overwrite function. The nonvolatile memory devices 110_1, 110_2, 110_3, and 110_4 may include a NAND flash memory in which data are capable of being written after the erase operation. The nonvolatile memory devices 110_1, 110_2, 110_3, and 110_4 may be configured to perform the erase operation in units of memory block and to perform the program operation in units of page.

When data are updated by the external host device, the memory controller 120 may invalidate original data and may write update data at a new page (e.g., a free page where data are not written).

The memory controller 120 may manage the nonvolatile memory devices 110_1, 110_2, 110_3, and 110_4 in units of super block or super page; however, by a unit different from the super block or the super page, the external host device may write data in the nonvolatile memory devices 110_1, 110_2, 110_3, and 110_4 and may read data from the nonvolatile memory devices 110_1, 110_2, 110_3, and 110_4.

For example, by a unit corresponding to a size of a logical page, the external host device may write or update data in the nonvolatile memory devices 110_1, 110_2, 110_3, and 110_4 and may read data from the nonvolatile memory devices 110_1, 110_2, 110_3, and 110_4.

In an embodiment, the external host device may update the data of the 3rd logical page number LPN3, the data of the 4th logical page number LPN4, the data of the 5th logical page number LPN5, and the data of the 8th logical page number LPN8, respectively.

The memory controller 120 may invalidate the original data of the 3rd logical page number LPN3, the original data of the 4th logical page number LPN4, the original data of the 5th logical page number LPN5, and the original data of the 8th logical page number LPN8 written in the nonvolatile memory devices 110_1, 110_3, and 110_4. For example, the invalidated data are shaded.

The memory controller 120 may write the update data of the 3rd logical page number LPN3, the update data of the 4th logical page number LPN4, the update data of the 5th logical page number LPN5, and the update data of the 8th logical page number LPN8 in the nonvolatile memory devices 110_1, 110_2, 110_3, and 110_4.

For example, based on the super block or the super page, the memory controller 120 may write the update data of the 3rd logical page number LPN3 at the fourth page of the first memory block BLK1 of the first nonvolatile memory device 110_1. The memory controller 120 may write the update data of the 4th logical page number LPN4 at the fourth page of the first memory block BLK1 of the second nonvolatile memory device 110_2. The memory controller 120 may write the update data of the 5th logical page number LPN5 at the fourth page of the first memory block BLK1 of the third nonvolatile memory device 110_3. The memory controller 120 may write the update data of the 8th logical page number LPN8 at the fourth page of the first memory block BLK1 of the fourth nonvolatile memory device 110_4.

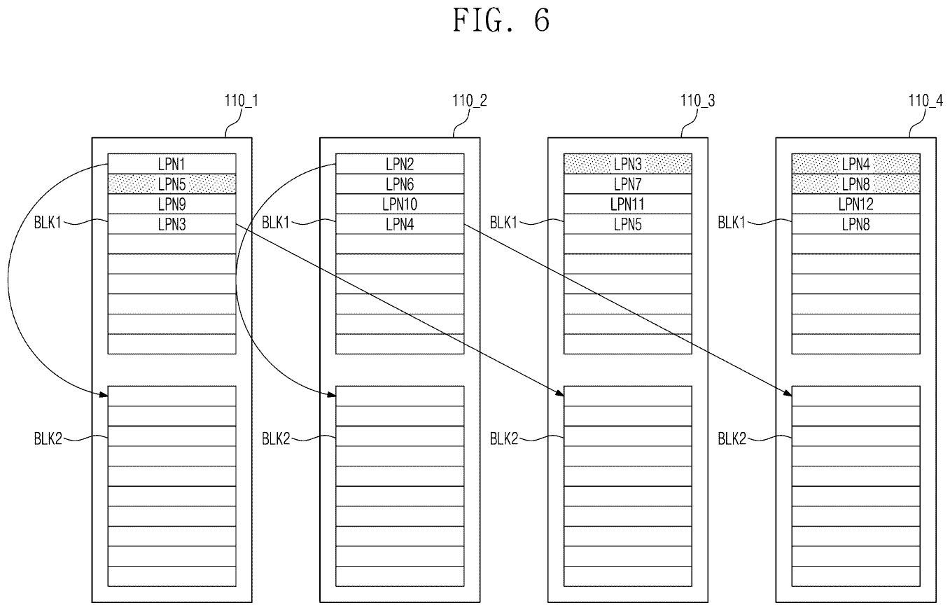

FIG. 6 illustrates an example in which garbage collection is performed in the nonvolatile memory devices 110_1, 110_2, 110_3, and 110_4. Referring to FIGS. 1 and 6, the garbage collection may refer to an operation of copying valid data of a specific super block to a new super block (e.g., a free super block). When the garbage collection is performed, the specific super block may be erased. For example, the garbage collection may be performed to secure a new free super block.

In an embodiment, the memory controller 120 may perform the garbage collection in the nonvolatile memory devices 110_1, 110_2, 110_3, and 110_4 based on logical page numbers and the super block or super page. The memory controller 120 may sequentially read data of the 1st to 12th logical page numbers LPN1 to LPN12 and may copy the sequentially read data to another super block, for example, the second super block of the second memory blocks BLK2.

For example, the memory controller 120 may read the data of the 1st logical page number LPN1 from the first memory block BLK1 of the first nonvolatile memory device 110_1 and may write the data of the 1st logical page number LPN1 at the first page of the second memory block BLK2 of the first nonvolatile memory device 110_1. The memory controller 120 may read the data of the 2nd logical page number LPN2 from the first memory block BLK1 of the second nonvolatile memory device 110_2 and may write the data of the 2nd logical page number LPN2 at the first page of the second memory block BLK2 of the second nonvolatile memory device 110_2.

The memory controller 120 may read the data of the 3rd logical page number LPN3 from the first memory block BLK1 of the first nonvolatile memory device 110_1 and may write the data of the 3rd logical page number LPN3 at the first page of the second memory block BLK2 of the third nonvolatile memory device 110_3. The memory controller 120 may read the data of the 4th logical page number LPN4 from the first memory block BLK1 of the second nonvolatile memory device 110_2 and may write the data of the 4th logical page number LPN4 at the first page of the second memory block BLK2 of the fourth nonvolatile memory device 110_4.

The memory controller 120 may perform the garbage collection by using the copyback operation. The memory controller 120 may read data from one super page of the first super block and may store the read data in the internal buffer 123 or the external buffer 130. The memory controller 120 may read the data from the internal buffer 123 or the external buffer 130 and may program the read data at one super page of the second super block.

In an embodiment, the capacity of the internal buffer 123 or the capacity of the external buffer 130 may be restricted to reduce manufacturing costs of the storage device 100. In an embodiment, the external buffer 130 may not be provided in the storage device 100, and the capacity of the internal buffer 123 may be restricted.

When the size of a buffer (e.g., the internal buffer 123 or the external buffer 130) available in the copyback operation of the garbage collection is smaller than the size of one super page, the memory controller 120 should perform the copyback operation for one super page two times or more.

In a conventional storage device, two or more copyback operations may be performed individually and may require independent execution times. The storage device 100 according to an embodiment of the present disclosure may reduce the time necessary to perform two or more copyback operations by interleaving the two or more copyback operations. Accordingly, the operating speed of the storage device 100 may be improved.

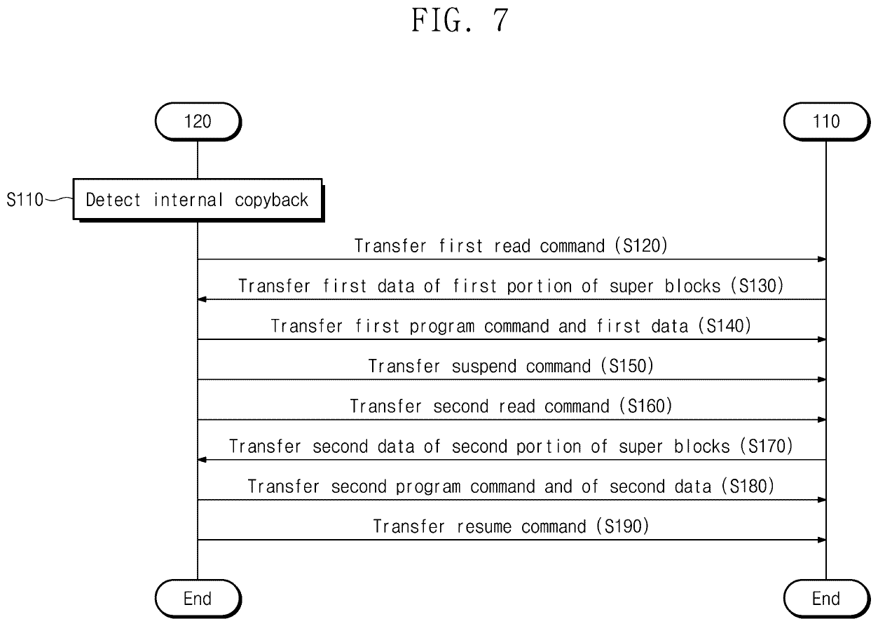

FIG. 7 illustrates an operating method of the storage device 100 according to an embodiment of the present disclosure. In an embodiment, an example of an operation in which first data and second data stored at a first portion and a second portion of a super page are coped to a third portion and a fourth portion of a super page is illustrated in FIG. 7.

Referring to FIGS. 1, 6, and 7, in operation S110, the memory controller 120 may detect internal copyback. For example, the memory controller 120 may detect that there is a need to perform copyback internally. For example, when garbage collection is required, the memory controller 120 may detect that there is a need to perform the internal copyback. For example, the memory controller 120 may detect that there is a need to perform the copyback operation for one super page two times or more.

In operation S120, the memory controller 120 may transfer a first read command. For example, the memory controller 120 may transfer the first read command to a first portion of super blocks. In response to the first read command, the nonvolatile memory devices 110_1, 110_2, 110_3, and 110_4 may perform the read operation at the first portion of the super blocks.

In operation S130, the first portion of the nonvolatile memory devices 110_1, 110_2, 110_3, and 110_4 may transfer the first data thus read to the memory controller 120. That is, the memory controller 120 may read data from some of the nonvolatile memory devices 110_1, 110_2, 110_3, and 110_4. For example, the memory controller 120 may read a portion of data of one super page of a super block by transferring the first read command to some nonvolatile memory devices among the nonvolatile memory devices 110_1, 110_2, 110_3, and 110_4. The first data thus read may be buffered in the internal buffer 123 or the external buffer 130.

In operation S140, the memory controller 120 may send a first program command and the first data. For example, the memory controller 120 may transfer the first program command and the first data to the first portion of the super blocks. In response to the first program command, the nonvolatile memory devices 110_1, 110_2, 110_3, and 110_4 may start the program operation of the first data at a third portion of one super page among the super blocks.

In operation S150, the memory controller 120 may transfer a suspend command. For example, the memory controller 120 may request to suspend the program operation by transferring the suspend command to some nonvolatile memory devices corresponding to the third portion of the super page program-requested by the first program command from among the nonvolatile memory devices 110_1, 110_2, 110_3, and 110_4.

In an embodiment, the memory controller 120 may request the suspend before the program operation is actually initiated in some program-requested nonvolatile memory devices. For example, when data are loaded to the page buffer blocks 230 (refer to FIG. 2) of the some program-requested nonvolatile memory devices, the memory controller 120 may request the suspend. In an embodiment, the operation of requesting the suspend after the program operation is initiated may hinder the reliability of data. The memory controller 120 according to an embodiment of the present disclosure may improve the reliability of programmed data by requesting the suspend before the program operation is initiated.

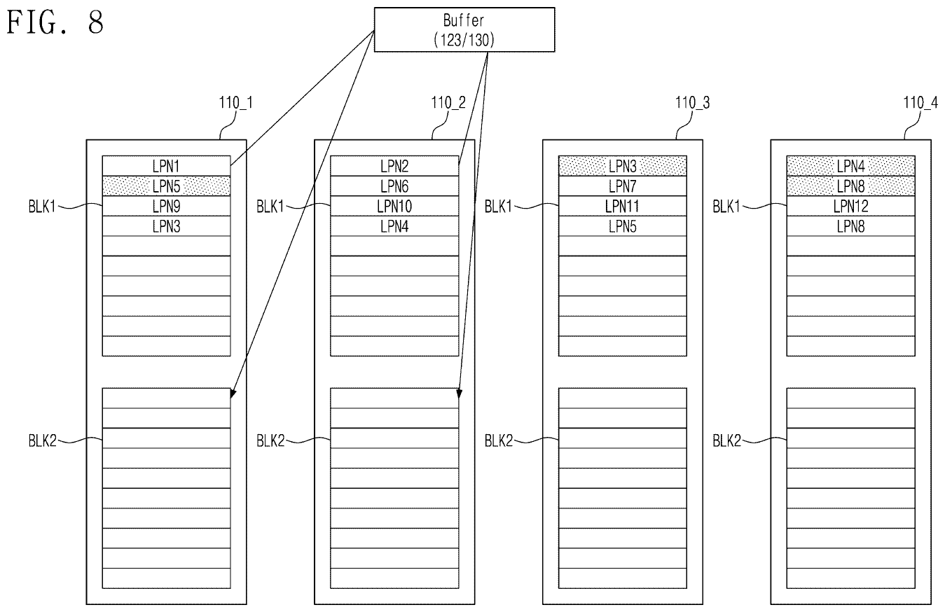

In an embodiment, FIG. 8 illustrates an example in which the read and program operations for some nonvolatile memory devices among the nonvolatile memory devices 110_1, 110_2, 110_3, and 110_4 are requested. Referring to FIGS. 1, 6, 7, and 8, for example, the data of the 1st logical page number LPN1 of the first memory block BLK1 of the first nonvolatile memory device 110_1 and the data of the 2nd logical page number LPN2 of the first memory block BLK1 of the second nonvolatile memory device 110_2 may be read. The read data may be stored in the buffer 123 or 130.

The memory controller 120 may request the first nonvolatile memory device 110_1 to write the data of the 1st logical page number LPN1 at the first page of the second memory block BLK2 of the first nonvolatile memory device 110_1. The memory controller 120 may request the second nonvolatile memory device 110_2 to write the data of the 2nd logical page number LPN2 at the first page of the second memory block BLK2 of the second nonvolatile memory device 110_2.

When data are loaded to some nonvolatile memory devices, the memory controller 120 may empty the internal buffer 123 or the external buffer 130.

In operation S160, the memory controller 120 may transfer a second read command. For example, the memory controller 120 may transfer the second read command to a second portion of the super blocks. In response to the second read command, the nonvolatile memory devices 110_1, 110_2, 110_3, and 110_4 may perform the read operation at the second portion of the super blocks.

In operation S170, the first portion of the nonvolatile memory devices 110_1, 110_2, 110_3, and 110_4 may transfer the second data thus read to the memory controller 120. That is, the memory controller 120 may read data from others of the nonvolatile memory devices 110_1, 110_2, 110_3, and 110_4. For example, the memory controller 120 may read another portion of the data of the one super page among the super blocks by transferring the second read command to other nonvolatile memory devices among the nonvolatile memory devices 110_1, 110_2, 110_3, and 110_4. The second data thus read may be buffered in the internal buffer 123 or the external buffer 130.

In operation S180, the memory controller 120 may send a second program command and the second data. For example, the memory controller 120 may transfer the second program command and the second data to a fourth portion of the super blocks. In response to the second program command, the nonvolatile memory devices 110_1, 110_2, 110_3, and 110_4 may start the program operation of the second data at the fourth portion of the one super page among the super blocks.

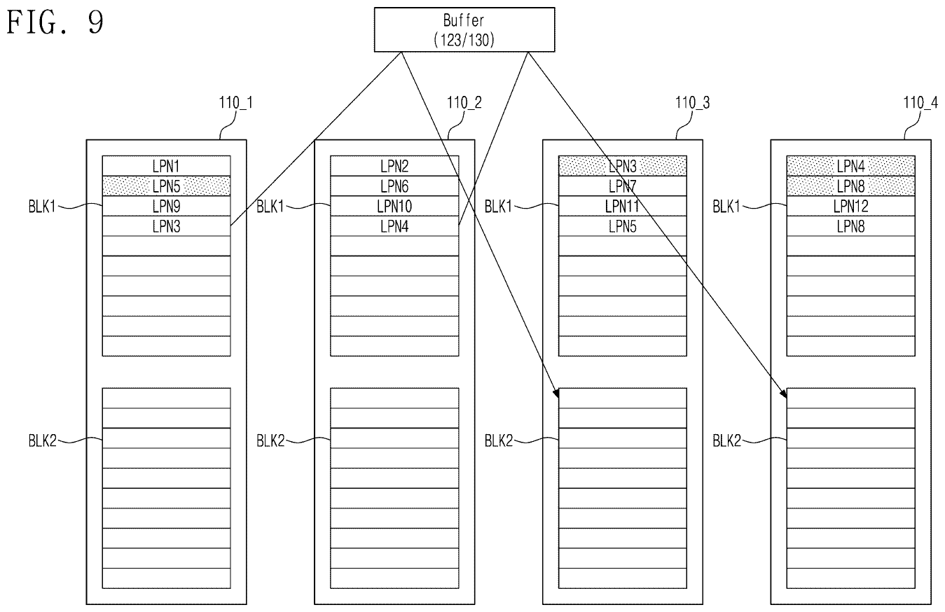

In an embodiment, FIG. 9 illustrates an example in which the read and program operations for other nonvolatile memory devices among the nonvolatile memory devices 110_1, 110_2, 110_3, and 110_4 are requested. Referring to FIGS. 1, 6, 7, and 9, for example, the data of the 3rd logical page number LPN3 of the first memory block BLK1 of the first nonvolatile memory device 110_1 and the data of the 4th logical page number LPN4 of the first memory block BLK1 of the second nonvolatile memory device 110_2 may be read. The read data may be stored in the buffer 123 or 130.

The memory controller 120 may request the third nonvolatile memory device 110_3 to write the data of the 3rd logical page number LPN3 at the first page of the second memory block BLK2 of the third nonvolatile memory device 110_3. The memory controller 120 may request the fourth nonvolatile memory device 110_4 to write the data of the 4th logical page number LPN4 at the first page of the second memory block BLK2 of the fourth nonvolatile memory device 110_4.

In operation S190, the memory controller 120 may transfer a resume command. For example, the memory controller 120 may request to resume the program operation by transferring the resume command to some nonvolatile memory devices corresponding to the third portion of the super page program-suspended by the suspend command from among the nonvolatile memory devices 110_1, 110_2, 110_3, and 110_4.

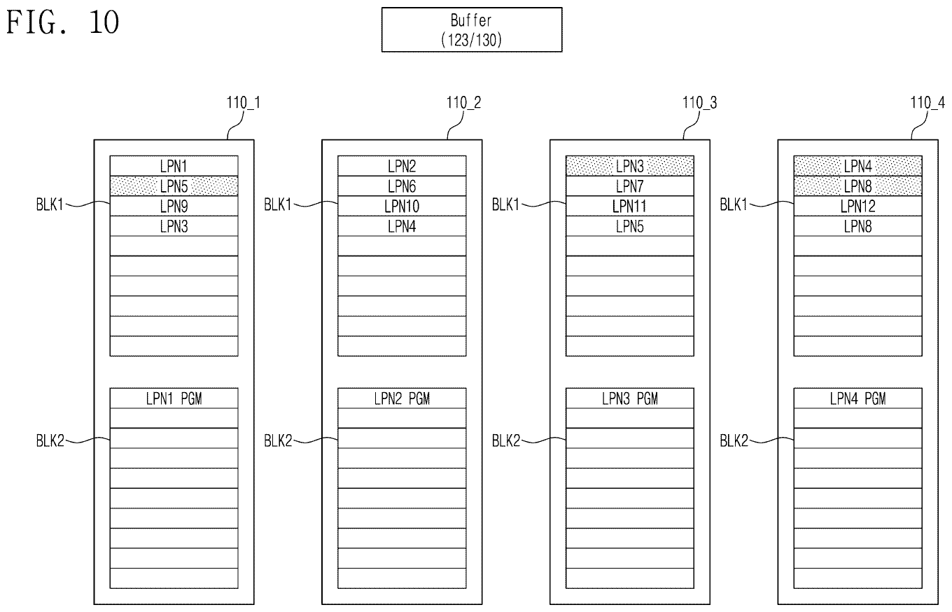

FIG. 10 illustrates an example in which data are copied by the copyback operations of FIGS. 8 and 9. Referring to FIGS. 1, 6, and 10, the data of the 1st logical page number LPN1, the data of the 2nd logical page number LPN2, the data of the 3rd logical page number LPN3, and the data of the 4th logical page number LPN4 may be written at the first super page of the super block of the second memory blocks BLK2 of the nonvolatile memory devices 110_1, 110_2, 110_3, and 110_4.

According to embodiments of the present disclosure, even though an available capacity of a buffer for garbage collection is insufficient, the program operations necessary for the copyback operation of the garbage collection may be interleaved by using the program suspend and resume scheme. Accordingly, the execution time of the garbage collection or the copyback operation may decrease, and the operating speed of the storage device 100 may be improved.

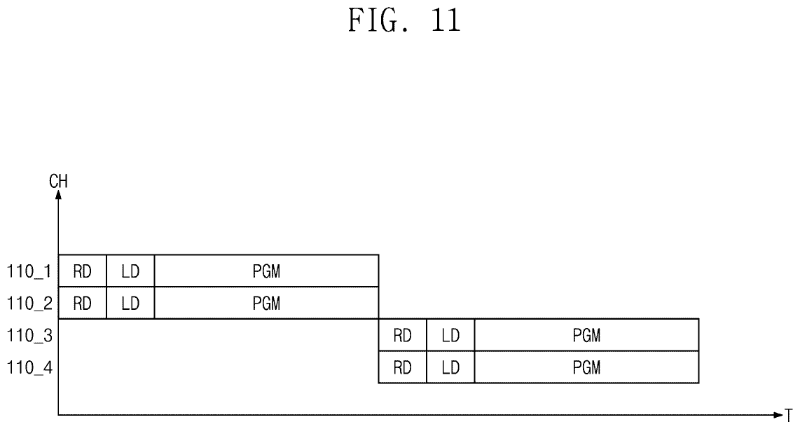

FIG. 11 illustrates an example in which copyback operations are performed without suspend and resume. In FIG. 11, the horizontal axis represents a time “T”, and the vertical axis represents operations of the nonvolatile memory devices 110_1, 110_2, 110_3, and 110_4.

Referring to FIGS. 1, 6, and 11, the memory controller 120 may perform the copyback operation for the first nonvolatile memory device 110_1 and the second nonvolatile memory device 110_2. For example, the memory controller 120 may perform reading RD for the first nonvolatile memory device 110_1 and the second nonvolatile memory device 110_2 by using the read command. The memory controller 120 may perform data loading LD for the first nonvolatile memory device 110_1 and the second nonvolatile memory device 110_2 by using the program command. Afterwards, the first nonvolatile memory device 110_1 and the second nonvolatile memory device 110_2 may perform programming PGM.

After the copyback operation for the first nonvolatile memory device 110_1 and the second nonvolatile memory device 110_2 is completed, the memory controller 120 may perform the copyback operation for the third nonvolatile memory device 110_3 and the fourth nonvolatile memory device 110_4. For example, the memory controller 120 may perform reading RD for the third nonvolatile memory device 110_3 and the fourth nonvolatile memory device 110_4 by using the read command. The memory controller 120 may perform data loading LD for the third nonvolatile memory device 110_3 and the fourth nonvolatile memory device 110_4 by using the program command. Afterwards, the third nonvolatile memory device 110_3 and the fourth nonvolatile memory device 110_4 may perform programming PGM.

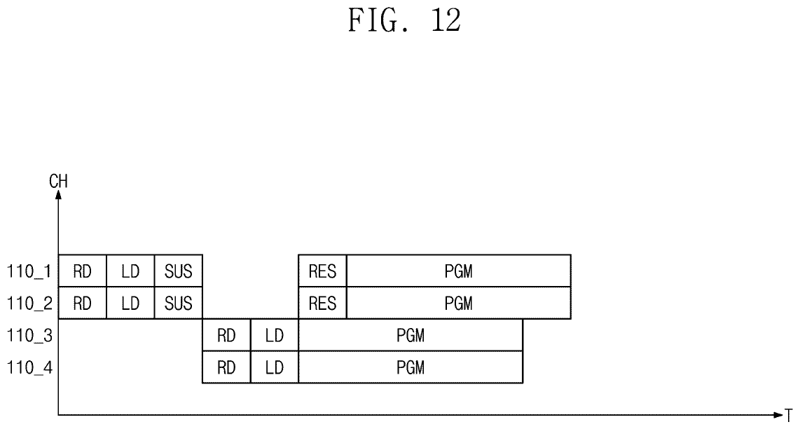

FIG. 12 illustrates an example in which copyback operations are performed by using suspend and resume. In FIG. 12, the horizontal axis represents a time “T”, and the vertical axis represents operations of the nonvolatile memory devices 110_1, 110_2, 110_3, and 110_4.

Referring to FIGS. 1, 6, and 12, the memory controller 120 may start the copyback operation for the first nonvolatile memory device 110_1 and the second nonvolatile memory device 110_2. For example, the memory controller 120 may perform reading RD for the first nonvolatile memory device 110_1 and the second nonvolatile memory device 110_2 by using the read command. The memory controller 120 may perform data loading LD for the first nonvolatile memory device 110_1 and the second nonvolatile memory device 110_2 by using the program command. Afterwards, the memory controller 120 may suspend (SUS) programming for the first nonvolatile memory device 110_1 and the second nonvolatile memory device 110_2 by using the suspend command.

After the programming of the first nonvolatile memory device 110_1 and the second nonvolatile memory device 110_2 is suspended, the memory controller 120 may start the copyback operation for the third nonvolatile memory device 110_3 and the fourth nonvolatile memory device 110_4. For example, the memory controller 120 may perform reading RD for the third nonvolatile memory device 110_3 and the fourth nonvolatile memory device 110_4 by using the read command. The memory controller 120 may perform data loading LD for the third nonvolatile memory device 110_3 and the fourth nonvolatile memory device 110_4 by using the program command. Afterwards, the third nonvolatile memory device 110_3 and the fourth nonvolatile memory device 110_4 may perform programming PGM.

After the programming of the third nonvolatile memory device 110_3 and the fourth nonvolatile memory device 110_4 is started, the memory controller 120 may start programming PGM for the first nonvolatile memory device 110_1 and the second nonvolatile memory device 110_2.

According to an embodiment of the present disclosure, when two or more copyback operations are required for the copyback of one super page, programming PGM of the two or more copyback operations may be interleaved. Accordingly, the execution time of the copyback operation may be reduced, the execution time of the garbage collection may be reduced, and the operating speed of the storage device 100 may be improved.

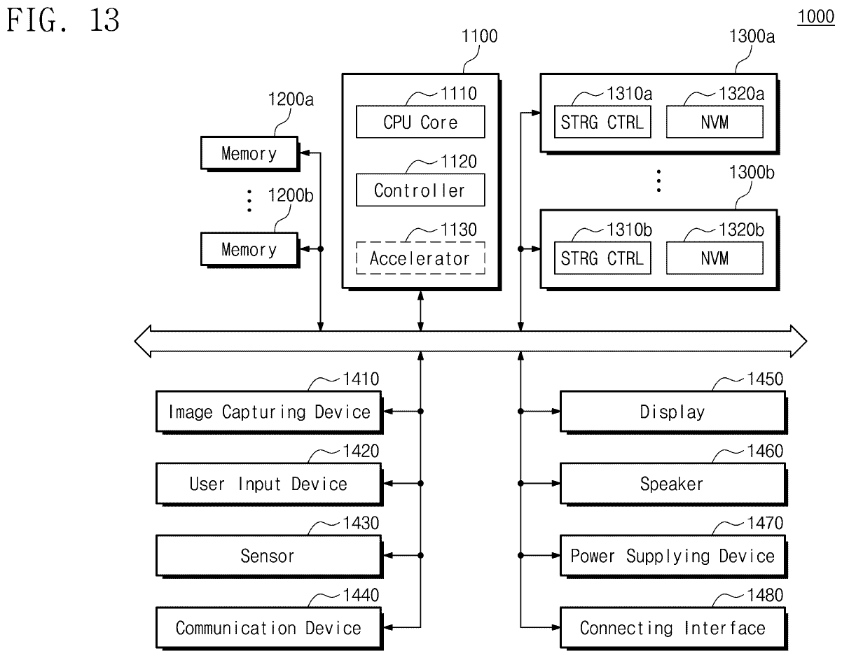

FIG. 13 is a diagram of a system 1000 to which a storage device is applied, according to an embodiment. The system 1000 of FIG. 13 may basically be a mobile system, such as a portable communication terminal (e.g., a mobile phone), a smartphone, a tablet personal computer (PC), a wearable device, a healthcare device, or an Internet of things (IOT) device. However, the system 1000 of FIG. 13 is not necessarily limited to the mobile system and may be a PC, a laptop computer, a server, a media player, or an automotive device (e.g., a navigation device).

Referring to FIG. 13, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 1000 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

The storage device 100 described with reference to FIGS. 1 to 12 may be implemented with the storage devices 1300a and 1300b. The storage devices 1300a and 1300b may be configured to perform the copyback operation or the garbage collection including the copyback operation by using the suspend and resume scheme. The storage devices 1300a and 1300b may interleave programming of two or more copyback operations by using the suspend and resume scheme.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

In the above embodiments, components according to embodiments of the present disclosure are referenced by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit, or circuits enrolled as an intellectual property (IP).

According to embodiments of the present disclosure, a copyback operation may be interleaved by using a buffer of a restricted capacity. Accordingly, a storage device providing an improved operating speed and an operating method of the storage device are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A storage device comprising:
a plurality of nonvolatile memory devices; and
a memory controller configured to control the plurality of nonvolatile memory devices,
wherein the memory controller is further configured to, in a copyback operation:
transfer first read commands to first nonvolatile memory devices among the plurality of nonvolatile memory devices,
transfer first program commands and first data read in response to the first read commands to second nonvolatile memory devices among the plurality of nonvolatile memory devices, and
transfer suspend commands associated with the first program commands to the second nonvolatile memory devices.

2. The storage device of claim 1, wherein the memory controller is further configured to, in the copyback operation:
transfer second read commands to third nonvolatile memory devices among the plurality of nonvolatile memory devices; and
transfer second program commands and second data read by the second read commands to fourth nonvolatile memory devices among the plurality of nonvolatile memory devices.

3. The storage device of claim 2, wherein the memory controller is further configured to, in the copyback operation, transfer resume commands to the second nonvolatile memory devices after transferring the second data and the second program commands to the fourth nonvolatile memory devices.

4. The storage device of claim 3, wherein the second nonvolatile memory devices are configured to stop program operations associated with the first program commands in response to the suspend commands and to resume the program operations associated with the first program commands in response to the resume commands.

5. The storage device of claim 4, wherein the memory controller is further configured to transfer the suspend commands to the second nonvolatile memory devices before the program operations associated with the first program commands are initiated in the second nonvolatile memory devices.

6. The storage device of claim 4, wherein the memory controller is further configured to transfer the suspend commands to the second nonvolatile memory devices after the first data are loaded to the second nonvolatile memory devices.

7. The storage device of claim 3, wherein the second nonvolatile memory devices are distinguished from the fourth nonvolatile memory devices.

8. The storage device of claim 3, wherein the memory controller is further configured to restrict a buffer corresponding to a first size of the first data or a second size of the second data so as to be used in the copyback operation.

9. The storage device of claim 3, wherein, based on the suspend commands and the resume commands, the memory controller is further configured to interleave first program operations of the first data and second program operations of the second data.

10. The storage device of claim 1, wherein the memory controller is further configured to perform the copyback operation as a portion of a garbage collection operation.

11. An operating method of a storage device which comprises a plurality of nonvolatile memory devices and a memory controller, the operating method comprising:
transferring, by the memory controller, first read commands to first nonvolatile memory devices among the plurality of nonvolatile memory devices, in a copyback operation;
transferring, by the memory controller, first program commands and first data read in response to the first read commands to second nonvolatile memory devices among the plurality of nonvolatile memory devices, in the copyback operation; and
transferring, by the memory controller, suspend commands associated with the first program commands to the second nonvolatile memory devices, in the copyback operation.

12. The operating method of claim 11, further comprising:
transferring, by the memory controller, second read commands to third nonvolatile memory devices among the plurality of nonvolatile memory devices, in the copyback operation; and
transferring, by the memory controller, second program commands and second data read in by the second read commands to fourth nonvolatile memory devices among the plurality of nonvolatile memory devices, in the copyback operation.

13. The operating method of claim 12, further comprising:
transferring, by the memory controller, resume commands to the second nonvolatile memory devices after transferring the second data and the second program commands to the fourth nonvolatile memory devices, in the copyback operation.

14. The operating method of claim 13, further comprising:
stopping, by the second nonvolatile memory devices, program operations associated with the first program commands in response to the suspend commands; and
resuming, by the second nonvolatile memory devices, the program operations associated with the first program commands in response to the resume commands.

15. The operating method of claim 14, wherein the transferring the suspend commands comprises:
transferring, by the memory controller, the suspend commands to the second nonvolatile memory devices before the program operations associated with the first program commands are initiated in the second nonvolatile memory devices.

16. The operating method of claim 14, wherein the transferring the suspend commands comprises;
transferring, by the memory controller, the suspend commands to the second nonvolatile memory devices after the first data are loaded to the second nonvolatile memory devices.

17. The operating method of claim 13, wherein the second nonvolatile memory devices are distinguished from the fourth nonvolatile memory devices.

18. The operating method of claim 13, wherein the memory controller restricts a buffer corresponding to a first size of the first data or a second size of the second data so as to be used in the copyback operation.

19. A storage device comprising:
a plurality of nonvolatile memory devices; and
a memory controller configured to control the plurality of nonvolatile memory devices,
wherein the memory controller is configured to, in a copyback operation belonging to a garbage collection operation:
transfer first read commands to first nonvolatile memory devices among the plurality of nonvolatile memory devices,
transfer first program commands and first data read in response to the first read commands to second nonvolatile memory devices among the plurality of nonvolatile memory devices, and
transfer suspend commands associated with the first program commands to the second nonvolatile memory devices,
wherein the memory controller is further configured to, in the copyback operation belonging to the garbage collection operation:
transfer second read commands to third nonvolatile memory devices among the plurality of nonvolatile memory devices, and
transfer second program commands and second data read by the second read commands to fourth nonvolatile memory devices among the plurality of nonvolatile memory devices, and
wherein the memory controller is further configured to, in the copyback operation belonging to the garbage collection operation, transfer resume commands to the second nonvolatile memory devices after transferring the second data and the second program commands to the fourth nonvolatile memory devices.

20. The storage device of claim 19, wherein the memory controller is further configured to, based on the suspend commands and the resume commands, interleave first program operations of the first data and second program operations of the second data.
